(19) United States
(12) Patent Application Publication
(10) Pub. No.: US 2008/0151485 A1
(43) Pub. Date: Jun. 26, 2008

(54) Memory Card Power Disrupt System

(75) Inventors: Curtis W. Thornton, Cary, NC (US); Gerard J. Hayes, Wake Forest, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/613,226

(22) Filed: Dec. 20, 2006

(51) Int. Cl. G06F 1/16; A47B 81/00

(52) U.S. Cl. 361/684; 312/223.2

(57) ABSTRACT

A mechanical interlock mechanism described herein prevents a user from removing a memory card while a portable electronic device is connected to an external power supply. The portable electronic device includes a memory port, a power connector, and a cover. The cover is movable between first and second positions. In the first position, the cover exposes the memory port. In the second position, the cover exposes the power connector and at least partially blocks the memory port and any memory card inserted in the memory port. Thus, the second position prevents the user from removing a memory card from the memory port while an external power supply is connected to the power connector.

### BACKGROUND

The present invention relates generally to portable electronic devices, and more particularly to portable electronic devices that use memory cards.

Consumers use a wide variety of portable electronic devices throughout their professional and personal lives. Exemplary portable electronic devices include cellular telephones, personal data assistants, multi-media players, wireless modems, etc. Many of these devices include removable memory cards that provide additional memory and/or user-specific identification information. For example, most wireless communication devices use a smart card, such as a subscriber identification module (SIM) card, that stores user identification and/or subscription information.

Memory cards typically fit into a card slot so that they can be removed and/or replaced by the user. One advantage of removable memory cards is the ability to use the same memory card with multiple devices so that data stored in the memory card does not need to be entered into each device. To ensure that data on the memory card is not corrupted when the memory card is removed from the portable electronic device, the power must first be disconnected from the memory card. Removing the memory card with the power supply connected may cause damage to the memory card and/or loss of data.

### SUMMARY

The present invention provides a mechanical interlock mechanism to prevent a user from removing a memory card from a port while a portable electronic device is connected to an external power supply. A portable electronic device according to the present invention includes a memory port, a power connector for an external power supply, and a cover. The cover is movable between a first position and a second position. In the first position, the cover exposes the memory port and any memory card in the memory port, and may at least partially block the power connector. In the second position, the cover at least partially blocks the memory port and any memory card in the memory port, and exposes the power connector. In this position, the cover prevents a user from inserting or removing a memory card while an external power supply is connected to the power connector. In one embodiment, the cover is movable to the first position only when the external power supply is disconnected. The first position enables the user to insert and/or remove a memory card from the memory port at any time.

### BRIEF DESCRIPTION OF THE DRAWINGS

FIG. 1 shows an exemplary portable electronic device with a cover according to one embodiment of the present invention in a first position.

FIG. 2 shows an exemplary portable electronic device with a cover according to one embodiment of the present invention in a second position.

FIG. 3 shows an exemplary portable electronic device with a cover according to a second embodiment of the present invention in a first position.

FIG. 4 shows an exemplary portable electronic device with a cover according to the second embodiment of the present invention in a second position.

FIG. 5 shows an exemplary portable electronic device with a cover according to a third embodiment of the present invention.

### DETAILED DESCRIPTION

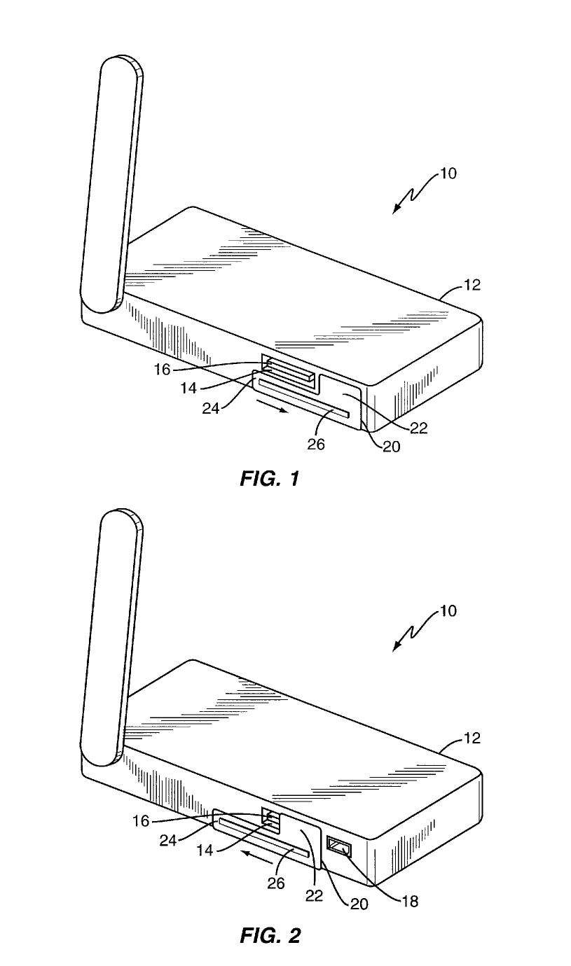

FIGS. 1 and 2 show a wireless modem 10 according to one embodiment of the present invention. The modem 10 includes a housing 12, a memory port 14 configured to receive a memory card 16, a power connector 18 configured to connect to an external power supply (not shown), and a movable cover 20 proximate to both the memory port 14 and the power connector 18. The cover 20 moves between first and second positions relative to the housing 12 to control access to the memory port 14, and therefore to control access to a memory card 16 in the memory port 14, depending on whether an external power supply is connected to the power connector 18.

FIG. 1 shows the cover 20 in the first position. In the first position, the cover 20 at least partially blocks the power connector 18 while exposing the memory port 14. Thus, the first position provides the user with access to the memory port 14 and/or to a memory card 16 in the memory port 14 only when an external power supply is not connected to the power connector 18. While not required, cover 20 may be biased in the first position.

To connect an external power supply to the power connector 18, the user moves the cover 20 to the second position to expose the power connector 18, as shown in FIG. 2. In this position, cover 20 at least partially blocks the memory port 14. Thus, when in the second position, the cover 20 enables the user to connect an external power supply to the exposed power connector 18 while physically preventing the user from inserting or removing a memory card 16 into or from the memory port 14. As a result, the second position safeguards data on the memory card 16 by preventing the user from removing the memory card 16 while an external power supply is connected to the power connector 18.

In one embodiment, the cover 20 may slidably connect to the housing 12 such that it slides between the first and second positions, as shown in FIGS. 1 and 2. For this embodiment, it will be appreciated that the cover 20 may slidably connect to an external or internal portion of the housing 12. The cover 20, shown in FIGS. 1-2, comprises a generally L-shaped cover 20 having a rectangular cover plate 22 extending from a rail 24. The cover plate 22 and rail 24 may be formed from one solid piece or may be formed from separate pieces secured together to form the cover 20.

The cover plate 22 at least partially blocks the memory port 14 and exposes the power connector 18 when the cover 20 is in the second position (FIG. 2). The cover plate 22 may also at least partially block the power connector 18 and expose the memory port 14 when the cover is in the first position (FIG. 1). The rail 22 slidably connects to a guide channel (not shown) to enable the cover 20 to slide between the first and second positions. The guide channel may be formed on an inner or outer portion of the housing 12.

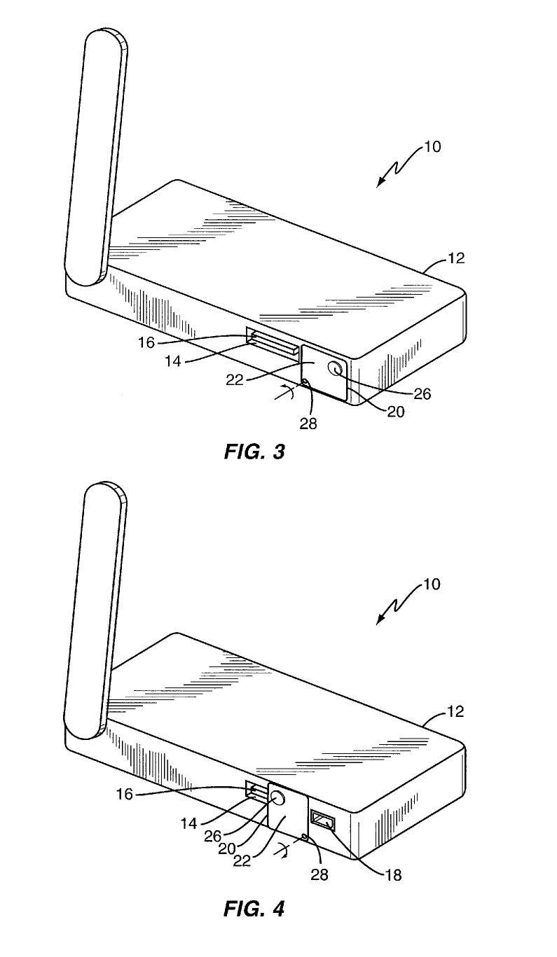

Cover 20 may further include a gripping area 26 disposed along at least a portion of the cover 20. The gripping area 26 may comprise any type of gripping surface configured to facilitate the movement of the cover 20 between the first and second positions. For example, the gripping area 26 may comprise a raised tab 26 disposed along a portion of the rail 24 as shown in FIGS. 1-2. Alternatively, the gripping area 26 may comprise an indentation in the cover plate 22 as shown in FIGS. 3-4.

In FIGS. 1 and 2, the cover plate extends upwardly from the rail 24. However, it will be appreciated that the cover plate 22 may extend from the rail 24 in any direction. For example, the cover plate 22 may extend downwardly from the rail 24 when the rail 24 is positioned along a portion of the housing 12 proximate a top portion of memory port 14 and/or power connector 18. It will be appreciated that other shapes and sizes may be used to implement the cover plate 22 and rail 24 of the present invention.

In another embodiment, the cover 20 may rotatably connect to the housing 12 such that it rotates or pivots between the first and second positions, as shown in FIGS. 3 and 4. The cover shown in FIGS. 3-4 comprises a generally rectangular cover plate 22 rotatably connected to the housing 12 by a pivot connector 28. FIG. 3 shows the cover plate 22 in the first position, while FIG. 4 shows the cover plate 22 in the second position. The pivot connector 28 may comprise any suitable connector that allows the cover plate 22 to rotate relative to the housing 12.

In FIGS. 3-4, the cover plate 22 rotates counter-clockwise about a pivot connector 28 connected to the housing 12 at a position below and between the memory port 14 and power connector 18, However, it will be appreciated that the cover plate 22 may pivot about any pivot connector 28 such that the cover plate 22 moves between the first and second positions. For example, the cover plate 22 may rotate clockwise about a pivot connector 28 connected to the housing 12 at a position above and between the memory port 14 and power connector 18. It will be appreciated that other shapes and sizes may be used to implement the cover plate 22 of the present invention.

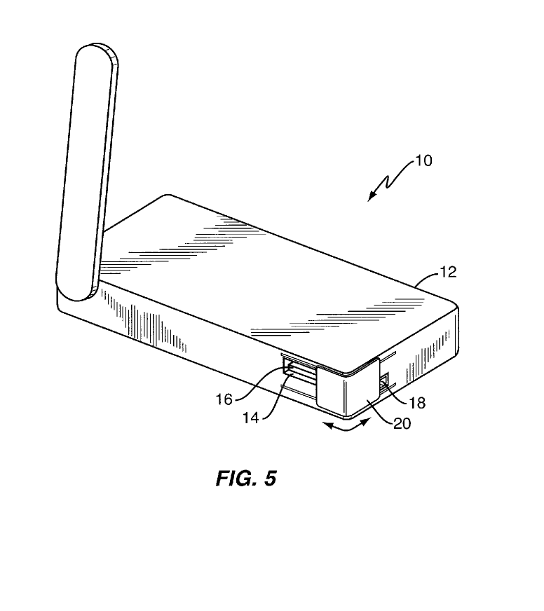

The present invention does not require that the memory port 14 and the power connector 18 be adjacent. FIG. 5 shows one exemplary embodiment where the memory port 14 and power connector 18 are disposed on different sides of the housing 12. When the memory port 14 and power connector 18 are disposed on opposite sides of the housing 12, the cover may comprise two interlinked cover plates, where in the first position a first one of the interlinked cover plates at least partially blocks the power connector 18 while a second one of the interlinked cover plates exposes the memory port 14. In the second position, the first one of the interlinked cover plates at least partially blocks the memory port 14, while the second one of the interlinked cover plates exposes the power connector 18

The present invention applies to any kind of portable electronic devices 10. Exemplary portable electronic devices 10 include but are not limited to cellular telephones, personal data assistants, wireless modems, and multi-media players, such as digital music players.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A portable electronic device comprising:
a memory port configured to receive a memory card;
a power connector configured to connect to an external power supply; and
a cover movable between first and second positions, wherein in said first position the memory port is exposed, and wherein in said second position the memory port is at least partially blocked by said cover and the power connector is exposed.

2. The portable electronic device of claim 1 wherein in said first position the power connector is at least partially blocked by said cover.

3. The portable electronic device of claim 1 wherein the cover comprises a slidable cover configured to slide between the first and second positions.

4. The portable electronic device of claim 1 wherein the cover comprises a rotatable cover configured to rotate between the first and second positions.

5. The portable electronic device of claim 1 wherein the cover is disposed on an outer surface of a housing of the portable electronic device.

6. The portable electronic device of claim 1 wherein the cover comprises a generally L-shaped cover comprising a cover plate extending from a rail.

7. The portable electronic device of claim 6 wherein in the second position, the cover plate at least partially blocks the memory port and exposes the power connector.

8. The portable electronic device of claim 6 wherein in the first position, the cover plate exposes the memory port.

9. The portable electronic device of claim 1 wherein the memory card comprises a subscriber identity module.

10. The portable electronic device of claim 1 wherein the power connector comprises a universal serial bus connector.

11. The portable electronic device of claim 1 wherein the portable electronic device comprises one of a cellular telephone, multi-media player, personal data assistant, and modem.

12. A method of protecting data on a memory card of a portable electronic device connected to an external power supply, the method comprising:
disposing a memory port in a housing of the portable electronic device, said memory port configured to receive the memory card;
disposing a power connector in the housing proximate the memory port, said power connector configured to connect to the external power supply; and
disposing a cover movable between first and second positions on the housing proximate the memory port and the power connector, wherein in said first position the memory port is exposed, and wherein in said second position the memory port is at least partially blocked by said cover and the power connector is exposed.

13. The method of claim 12 wherein in said first position the power connector is at least partially blocked by said cover.

14. The method of claim 12 wherein the cover slides between the first and second positions.

15. The method of claim 12 wherein the cover rotates between the first and second positions.
